(19) United States
(12) Patent Application Publication
(10) Pub. No.: US 2015/0113602 A1
(43) Pub. Date: Apr. 23, 2015

(54) METHOD AND SYSTEM FOR AUTHENTICATION OF COMMUNICATION AND OPERATION

(71) Applicant: SERENTIC LTD., Kfar Saba (IL)

(72) Inventors: David Korman, Kfar Saba (IL); Efraim Sasson, Kfar Tavor (IL)

(21) Appl. No.: 14/399,165

(22) PCT Filed: May 6, 2013
(86) PCT No.: PCT/IL2013/050385

§ 371 Date: Nov. 6, 2014

Related U.S. Application Data
(60) Provisional application No. 61/688,084, filed on May 8, 2012.

(51) Int. Cl. H04L 29/06

(52) U.S. Cl. CPC H04L 63/08
USPC 726/4

(57) ABSTRACT

The subject matter discloses at a first electronic entity, a method for authenticating the first electronic entity by a second electronic entity, the method comprising: receiving, from the second electronic entity, a request for authenticating the first electronic entity; partitioning an at least one resource as a result of the receiving the request; wherein the at least one resource being one member of a group consisting of a memory partition, a disk partition, a chip partition, a control resource and a hardware logic; and providing to the second electronic entity an access permission to the at least one resource; wherein the access permission being for the authenticating; wherein the authenticating being by utilizing the at least one resource; thereby enabling the second electronic entity the authenticating of the first electronic entity by utilizing the at least one resource.

### BACKGROUND

The present disclosure relates to securing an electronic entity, to communication and to performance.

Communication between pluralities of computerized device is typically authenticated by Multi-factor authentication.

Multi-factor authentication is commonly found in electronic computer authentication. Multi-factor authentication seeks to decrease the probability that the requestor is presenting false evidence of its identity. The number of factors is important as it implies a higher probability that the bearer of the identity evidence indeed holds that identity in another realm (e.g., computer system versus real life).

Common factors are: a factor related to knowledge of a user e.g., his password, his PIN, pattern; a physical factor (e.g., ATM card, smart card); and a biometric characteristic, such as a fingerprint, what you know, what you have, what you are.

U.S. Pat. No. 7,266,658 to Harrington Bradley Ryan et al discloses a system, method, and computer program product for prohibiting unauthorized access to a protected region of memory.

### BRIEF SUMMARY

One exemplary embodiment of the disclosed subject matter is at a first electronic entity, the first electronic entity comprising an at least one resource, a method for authenticating the first electronic entity by a second electronic entity, the method comprising: receiving, from the second electronic entity, a request for authenticating the first electronic entity; partitioning the an at least one resource as a result of the receiving the request; and providing to the second electronic entity an access permission to the at least one resource; wherein the access permission being for the authenticating the first electronic entity by the second electronic entity; the authenticating being by utilizing the at least one resource by the second electronic entity; thereby enabling the second electronic entity the authenticating of the first electronic entity by utilizing the at least one resource.

According to some embodiments the at least one resource being one member of a group consisting of a memory partition, a disk partition, software logic, a chip partition, a control resource, an analog component, a digital component, a signal, a mix signal and a hardware logic;

According to some embodiments the authenticating of the first electronic entity being for one member of a group consisting of communicating with the first electronic entity, utilizing the at least one resource by the first electronic entity and for manipulating data or structure of the first electronic entity.

According to some embodiments the method further comprising: establishing a communication session with the second electronic entity; and utilizing the region for communicating with the second electronic entity during the communication session; thereby enabling the second electronic entity the authenticating of the first electronic entity during the communication session.

According to some embodiments the method of; further comprising continuously authenticating the second electronic entity, wherein the authenticating comprising monitoring an operation of the second electronic entity with the one or more resources.

According to some embodiments the method further comprising: negotiating with the second electronic entity for determining the at least one resource prior to the partitioning the at least one resource.

According to some embodiments the method further comprising: establishing a communication session with the second electronic entity; continuously negotiating with the second electronic entity for generating a communication protocol for communicating with the second electronic entity during the communication session; and continuously changing the communication protocol, during the session.

According to some embodiments the method further comprising: utilizing the communication protocol for charging; wherein the charging being changed during the communication session thereby providing a secure charging.

One other exemplary embodiment of the disclosed subject matter is At a first electronic entity, a method for authenticating a second electronic entity by the first electronic entity, the method comprising: sending to the second electronic entity, a request for authenticating the second electronic entity; receiving from the second electronic entity an access permission to an at least one resource of the second electronic entity; wherein the access permission being for the second electronic entity; and utilizing the at least one resource for monitoring the second electronic entity; and by the monitoring, authenticating the second electronic entity.

According to some embodiments the method further comprising: continuously certifying the second electronic entity, according to one member of a group consisting of: utilizing the at least one resource for monitoring changes in an operation of the second electronic entity, utilizing the at least one resource for monitoring changes in a behavior of a user of the second electronic entity and utilizing the at least one resource for monitoring changes in an environment of the second electronic entity.

one other exemplary embodiment of the disclosed subject matter is, a method for communicating with a second electronic entity, the method comprising the steps of: establishing a communication session with the second electronic entity; negotiating with the second electronic entity for determining characteristic of a communication protocol and utilizing the communication protocol for communicating with the second electronic entity;

According to some embodiments the method further comprising continuously adapting the communication protocol to characteristic of the session.

According to some embodiments the characteristic being one member of a group consisting of behavior of a user, and environment changes, changes in operation of the first electronic entity and the second electronic entity.

One other exemplary embodiment of the disclosed subject matter is a method comprising the steps of: establishing a communication session with a electronic entity; continuously certifying, during the communication session, the electronic entity, wherein the certifying being changed during the session according to one member of a group consisting of: changes in an operation of the first electronic entity, changes in a behavior of a user of the first electronic entity and to changes in an environment of the first electronic entity.

One other exemplary embodiment of the disclosed subject matter is a charging method, the method comprising the steps of establishing a communication session between a charger and a charged device; wherein the communication protocol being for the charging; changing characteristic of the charging during the charging, thereby providing a secured charging.

One other exemplary embodiment of the disclosed subject matter is a first electronic entity, the first electronic entity comprising an at least one resource, a method for sharing resources of the first electronic entity by a second electronic entity, the method comprising: receiving, from the second electronic entity, =a request for sharing the at least one resource with the first electronic entity; partitioning the an at least one resource as a result of the receiving the request; and providing to the second electronic entity an access permission to the at least one resource; wherein the access permission being for sharing the at least one resource by the second electronic entity.

One other exemplary embodiment of the disclosed subject matter is a first electronic entity, the first electronic entity comprising an at least one resource, a method for authenticating the first electronic entity by a second electronic entity, the method comprising: receiving, from the second electronic entity, a request for authenticating the first electronic entity; partitioning the an at least one resource as a result of the receiving the request; and providing to the second electronic entity an access permission to the at least one resource; wherein the access permission being for authenticating the at least one resources by the second electronic entity; thereby enabling the second electronic entity the authenticating of the at least one resource entity by utilizing the at least one resource.

One other exemplary embodiment of the disclosed subject matter is an electronic entity, the electronic entity comprising an at least one resource, the electronic entity is configured for receiving, from a second electronic entity, a request for authenticating the electronic entity; partitioning the an at least one resource as a result of the receiving the request; and providing to the second electronic entity an access permission to the at least one resource; wherein the access permission being for the authenticating the first electronic entity by the second electronic entity; the authenticating being by utilizing the at least one resource; thereby enabling the second electronic entity the authenticating of the first electronic entity by utilizing the at least one resource.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a secured environment, in accordance with some exemplary embodiments of the subject matter;

FIG. 2a show a block diagram of a watch and a mobile device configured for secure communicating, in accordance with some exemplary embodiments of the disclosed subject matter; FIG. 2b shows the watch;

FIG. 3 shows a flowchart diagram of a trusted communication method, in accordance with some exemplary embodiments of the disclosed subject matter;

FIG. 4 shows a flowchart diagram of a trusted certification method, in accordance with some exemplary embodiments of the disclosed subject matter;

FIG. 5 shows a flowchart diagram of a method securing and certifying the communication according to the behavior of the user, in accordance with some exemplary embodiments of the disclosed subject matter;

FIG. 6 shows a flowchart diagram of a method for secure charging, in accordance with some exemplary embodiments of the disclosed subject matter, and

FIG. 7 shows an exemplary scenario of using the region for interacting with peripherals.

### DETAILED DESCRIPTION

The term control resource refers herein to an element that controls software and/or hardware and/or mechanical operation. Example of such control resources are a controller, SoC (System on Chip), DSP (Digital Signal Processing), CPU and MODEM.

The term electronic entity refers herein to peripheral, control resource, processing, modules, a computerized device and interface.

The term environment of an electronic entity may refer to a user of a computerized device, a resource of a computerized device, a network connected to the computerized device, a person or another computerized device or an object in the proximity of the computerized device.

The term region refers herein to resources of an electronic entity that are allocated for performing a communication session. Examples of such resources are memory partition, disk partition, chip partition, one or more control resources and hardware logic. Examples of hardware logic are gates and flip flops and/or HW analog such as transistor and/or a wire.

The term region access parameter refers herein to parameters that enable an electronic entity to access a region of another electronic entity. Such parameters include ports through which a control resource can be accessed or address map.

One technical problem dealt with by the present disclosure is the authenticating of a computerized device. Authenticating by parameters such as user name and password or keys may be detected and analyzed by an attacker. A multi factor authentication is cumbersome for the user and may also be detected by a third party (man in the middle) and/or internal threats such as side channel attacks.

One technical solution is a shared secured and/or unique region that enables an electronic entity to communicate with one or more other electronic entities; that is to say, a first electronic entity allocates a first region and enables a second electronic entity to access the first region while the second electronic entity allocates a second region and enables a first electronic entity to access the second region. The first electronic entity and the second electronic entity generate a protocol which is unique to the first and to the second electronic entities. Such a protocol may also be unique to the communication session. Such a unique protocol is hard to break by a third party due to its uniqueness, structure and behavior. The first electronic entity communicates with the second electronic entity via a second region which may be embedded in the second electronic entity. The first electronic entity continuously secures and authenticates the communication, the second region by controlling and monitoring the second region and by controlling and monitoring the second electronic entity via the second region. The second electronic entity communicates with the first electronic entity via the first region which may be embedded in the first electronic entity. The second electronic entity continuously secures and authenticates the communication, the first region and the first electronic entity by controlling and monitoring the first region and by controlling and monitoring the first electronic entity via the first region.

One other technical problem is the certification of the identity of parties in the communication session. A typical certification is performed in a beginning of a session, while an attacker may attack one of the electronic entities that participate in the session after the session has started.

One other technical solution is to continuously certifying the electronic entities that participate in the session by continuously learning the behavior of the devices, the behavior of the users of the device and the environment of the device and by suspecting or canceling a certificate when detecting a change in the behavior.

One other technical solution is a dynamic, scalable and unique certification

One other technical problem is the performance of a network such as a virtual private network and/or virtual machines. Typically a user that wishes to work with a file that is located in a centralized server has to continuously communicate with the server. Such a communication may cause performance and a security problem since the access to the file is through a network; additionally a fail of a communication between the computer devices causes a denial of service.

One technical solution is a region on a computerized device of the user. Whenever a user wishes to communicate with the server, the user's computerized device allocates a region and sends to the server the unique and/or dynamic access parameters to the region. In some embodiments, for example, when the server and the user's computerized device belong to the same organization, such parameters may already reside in the server. The server receives access permission to the region and transfers the file to the region of the user. The user can access the file through this region. When the user does not need the file, the user may return the file to the server via the region. The region is continuously authenticated by both the server and the user's computerized device, thus providing a secure access to the file without having a denial of service, and with better performance. Such a solution overcomes side channel attacks.

One other technical problem is the authenticating and communicating of electric chargers. In many cases electric charges counterfeited. Such counterfeited electric charges may be dangerous and may also cause damages to the charged device.

One other technical problem is decoying the charged device during the charging operation.

One technical solution is a charging communication protocol. Such a protocol is unique to the charger, to the charged device and to the charging session. Such a protocol enables the authenticating of the charger while securing the charging from an attack.

One other technical problem is a deterministic multifactor.

One technical solution is a dynamic, differential and scalable multifactor which is also unique to the session. Such a multifactor is composed of a plurality of factor taken from a plurality of devices participating in the session according to analysis of resources risks and performance and according to history of communication. Embodiments of the invention disclose a method and a system for managing trusted communication environment. Such a method and a system also adjusted the communication to the user and/or device and/or environment behavior and provide a protocol which is unique to the session. Such a uniqueness is based, inter-alia, on the users, the devices and the environments that are participating in the session, on the data that is transferred and on the type of the session. Such a protocol may be dynamically changed in order to secure the communication and participates in the communication session.

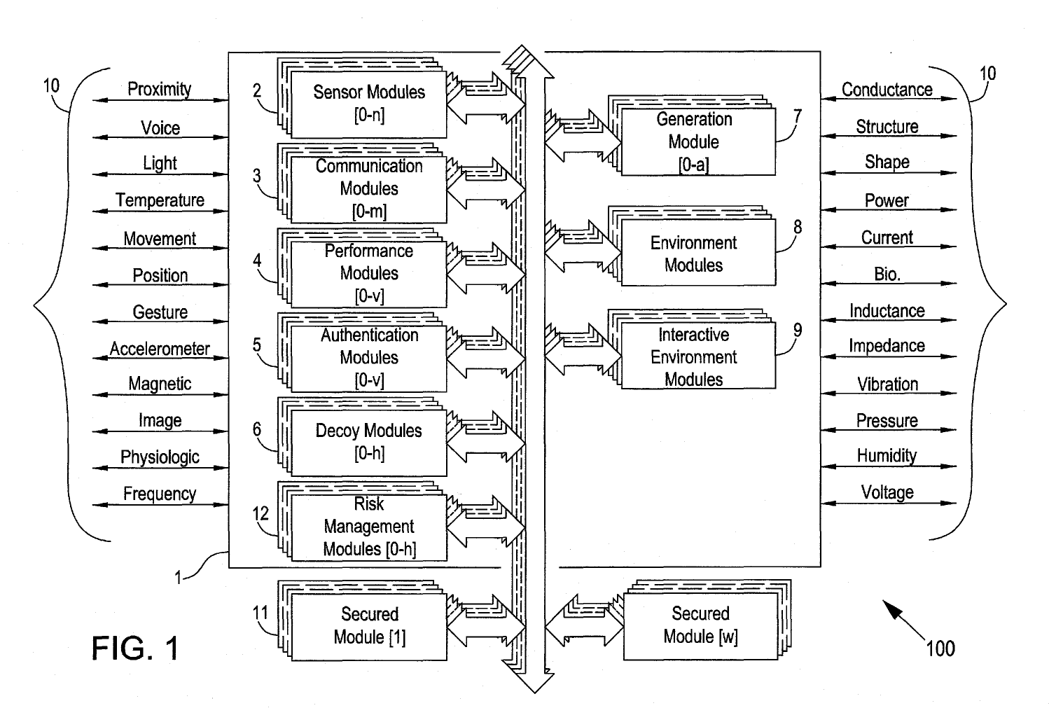

Referring now to FIG. 1 showing a secured environment, in accordance with some exemplary embodiments of the subject matter. Secured environment 100 includes a secured module 1, a sensor module 2, a communication module 3, a performance module 4, an authentication module 5, a decoy module 6, a generation module 7, an environment module 8 an interactive environment module 9 and risk management module 12.

Secured module 1 is configured for securing a communication session. Secured module 1 may be embedded in a computerized device. Such a computerized device may be an authenticating watch or a cellular device. The authenticating watch may be a watch that is adapted, inter alia, for communicating and/or authenticating and/or certificating an access to a computerized device. The Secured module 1 may receive input from the sensor module 2. The input of the sensor module 2 may be sent to other computerized devices that participate in the session for providing a dynamic continuous and/or unique certificate. The input of the sensors 2 is also used for the authentication and for securing the operation of the computerized device. The input from the sensor module 2 may be also used for detecting, analyzing and for predicting a threat. Examples for such input are proximity indicator, voice, wireless data, light, temperature, movement indication, position, gesture, magnetic, image, physiologic and frequency humidity display and voltage.

The sensor module 2 is configured for sensing the environment of the computerized device. The sensor module 2 includes sensors 10. The sensors 10 include proximity sensors, voice sensors, movement sensors, light sensors, temperature sensors, positioning sensors, gesture sensors, magnetometer, image detectors, physiologic sensors such as heartbeat sensors, frequency sensors, conductance sensors, shape detectors, current sensor, biometric sensors, inductance sensors, impedance sensors, vibration sensors, accelerometer sensor, pressure sensors, humidity sensors voltage sensors structure (pressure and cap-sense) sensors and temperature sensor. The sensor module 2 may also include a voice recorder. The sensor module 2 analyses the data that is received from the sensor. When detecting a risk, problem in the communication, such as a possible threat to the communication. The sensor module 2 notifies the Secured module 1. The Secured module 1 may authenticate the device.

The sensing may also be used for learning the environment. The learning is for adapting the communication to threats and to operation of the device. For example device A initiates a session with device B for issuing a payment. An image captured by a camera of device B may be used for authenticating.

The communication module 3 is configured for providing a communication with another computerized device. Examples of communication sessions are data transfer and resource sharing. The communication module may also include drivers to wired and/or wireless communication.

The performance module 4 is configured for improving the performance of the communication.

The authentication module 5 is configured for authenticating other computerized devices. In some embodiments the authentication of the computerized devices is performed via one or more regions of the computerized devices; such that a first computerized device manages and controls a region of a second computerized device and vice versa. For example, in order to authenticate a communication between two cellular telephones, the authentication module 5 of each cellular telephone may gain control on a region of the that is defined by the other cellular telephone and may authenticate the access by writing and reading from the portion of memory, or by commanding the other device to write and/or read to this portion of memory. After the regions of each computerized device are authenticated by the other electronic entities the communication is established. The authenticating may be done continuously throughout the communication session.

The decoy module 6 is configured for detecting an attempt to attach the device or the communication session, for example, by analyzing the input of the sensors 10.

The generation module 7 is configured for partitioning the regions. The generation module may also include the region.

The risk management modules 12 are configured for analysis the risk for securing the protocol, the device participating in the protocol the region.

The interactive environment system-module 9 is configured for combining internal data with data received from other electronic entities and analyzing the combined data for determining if the other computerized device is in the common-environment. By common-environment is meant environment in which the two entities can operate and communicate. In one embodiment two electronic entities are allowed to communicate and/or operate only in the same common-environment. Sensors and/or cameras of one computerized device may transfer partial output to the other computerized device and vice versa; the combined data is analyzed by each of the electronic entities in order to verify that the two electronic entities are in the same environment. For example an image from one computerized device can be compared with an image of a second computerized device for determining that the two computerized device are in the same area.

The module may also map the location of a device relative to the one or more other devices.

The environment module 8 is configured for analyzing the environment for improving the authentication, operation, performance, functionality and the communication.

The secured module 1 may communicate and or operate with other secured modules of other electronic entities (10 and 11)

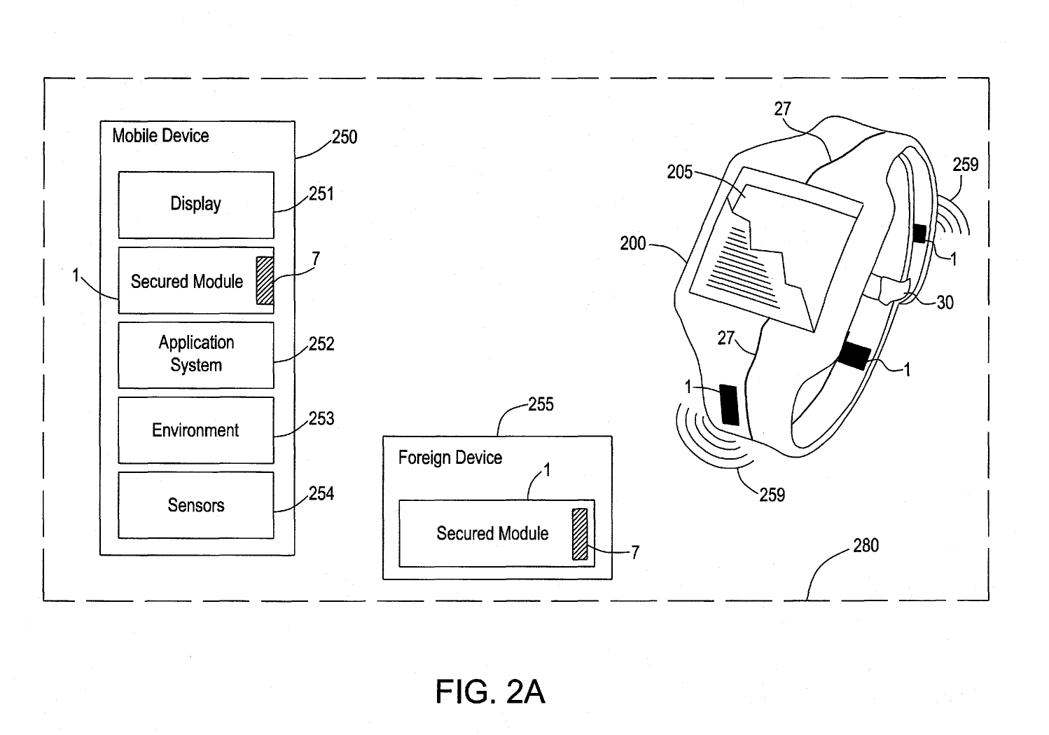

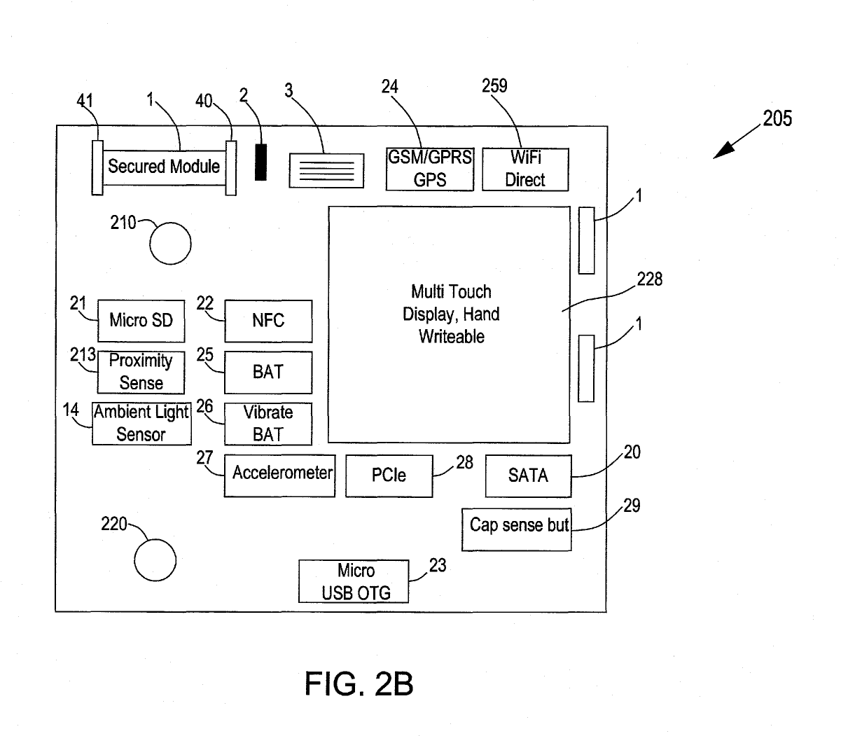

FIG. 2a show a block diagram of a watch and a mobile device configured for secure communicating, in accordance with some exemplary embodiments of the disclosed subject matter; FIG. 2b shows the watch, in accordance with some exemplary embodiments of the disclosed subject matter.

The environment 280 may include a watch 200 and a mobile device 250.

Watch 200 includes: a locker 30, a secured module 1, a WIFI module 259, an accelerometer 27, a locker 30 and a other components 205. The other components 205 include a GPRS module 24, a micro SD 21, an NFC 22, a battery 25, an ambient light sensor 14, a variable battery 26, a PCIe 28, a cup sense button 29, a micro USB OTG 23, an accelerometer 27, a proximity sensor 213 voice means 210, a display 228, a camera 220 a secure module 1, regions 40 and 41, a communication module 3 and SATA 20.

The secured module 1 is configured for providing the communication between the watch 200 and the mobile device 250. The secure communication may be for authenticating a user of the mobile device 250 an environment of the mobile device 250 and the mobile device 250 behavior and for alarming and/or interacting and/or informing the mobile device 250 when detecting a threat by the watch 200 and vice versa. Such a treat may be a person, a foreign device 23 and the like. The architecture of the secured module 1 is explained in greater details in FIG. 1. The system is configured for generating an intelligent communication. In some embodiments the secured module is a chip.

The WIFI module 259 and the NFC module 22 enable the communication between the watch 200 and mobile device 250.

The GPRS module 24 provides the location of the watch 200. The location may be used for authenticating and/or certifying the watch 200 by the mobile device 250 and vice versa; for example, the watch 200 may not be authenticated by the mobile deice 250 if the watch 200 is not in the same geographic region as the cellular device 250.

The Micro SD 21 is used for storing parameters related to the system.

The battery 25, the variable battery 26 and are the power supply of the watch 201.

The cup sense button 29 is for interacting with the user.

The PCIE (PCI EXPRESS) 28 is configured for communicating with PCI.

The micro USB OTG 23 is configured for charging the battery.

The accelerometer 27 is a sensor that is configured for measuring movement.

The proximity sensor 213 is configured for measuring proximity of objects.

The SATA 20 is a bus interface that is configured for connecting host bus adapters to the hard disk drives (not shown).

The ambient light 14 is a light sensor that may measure proximity.

The watch 200 and mobile device 250 communicate via the network. The network may be WIFI, cellular, NFC, and the like.

The mobile device 250 includes a display 251 for interacting with the user, secured module 1 for communicating with the watch 200 an application system 252 for operating the mobile device 50, an environment 253 and sensors 254. The secure module 1 may also include a region 7.

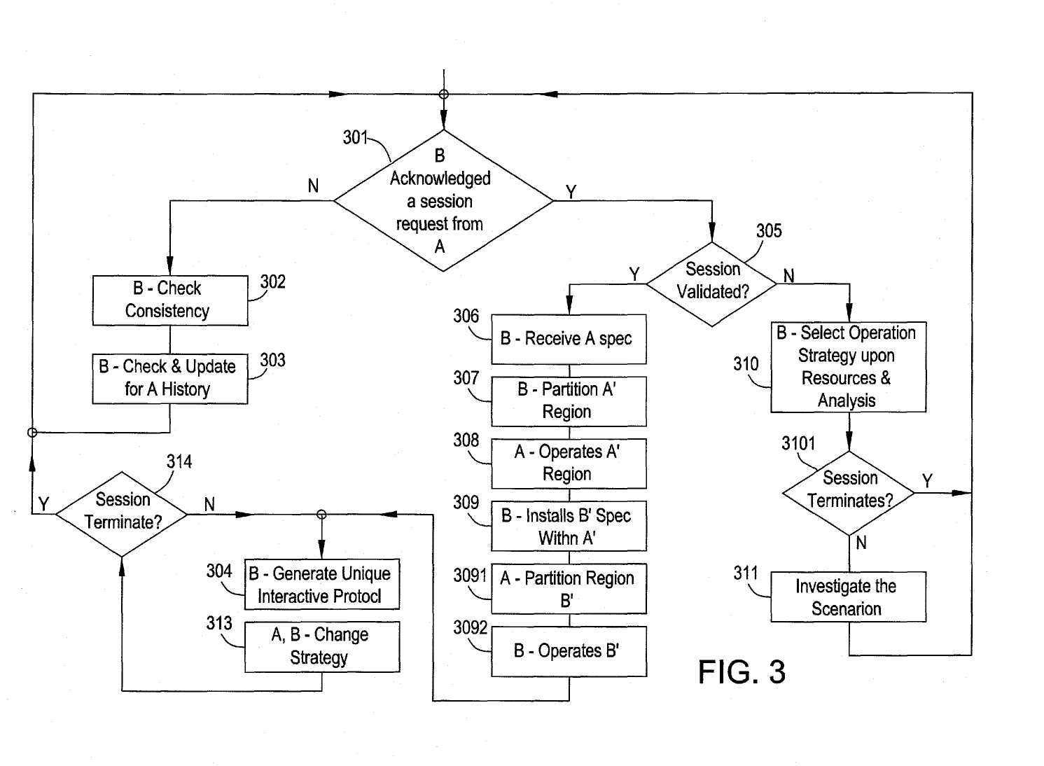

FIG. 3 shows a flowchart diagram of a trusted communication method, in accordance with some exemplary embodiments of the disclosed subject matter.

According to some embodiments a communication is performed via region. That is to say, device A partition region A′ in device B and device B partition region B′ in device A. The regions are partitioned according to a specification, and according to a negotiation between the devices. For example, device B may request device A to change the specification of A′ as a result of an analysis performed by device B. In such a case, the device in which the region is built may request the other device to change the specification of the region as a result of the analysis. Such a request has to be approved by the other device. If both devices do not agree on the specification of any of the regions, the communication session may fail. During the session of partitioning the region any device may change the requirement of a region according to new security and performance events. The regions are, thus, built interactively by both device A and device B. The decisions or an analysis of both devices may have similar priority; in some embodiments or the priority of a decision of any of the devices may be changed dynamically and interactively by both devices. The regions are unique to the devices that participate in the session and to the session and, thus, cannot be copied to another device. The regions may be autonomous, that is to say, a region A′ in device B may be autonomously controlled by device A.

In some embodiments the communication is performed by a plurality of peripherals, in such a case the resources for allocating the region are provided by third party.

The regions are used for the communication such that when device A wishes to send data to device B the data is placed in region B′ that is built in device A and vice versa. In some embodiments each device monitors the operation of the other device on the region that was allocated to the other device. The monitoring is for authenticating the operation of the other device, for preventing, inter alia, an attack of a third device. For example, device A monitors B′ region for authenticating the operations of A on B′ region and for preventing an attack of a third device on B′. The monitoring may include monitoring the resources and the environment of the region. The monitoring may also include monitoring the data that is transferred to and from the region.

The regions are autonomous, as oppose to virtual machine; for example each region may have its own boot file each region may operate autonomously to the status of the device in which the region is located. For example region A′ in device B may be operable even if device B is not operated. In some cases, for example, Device B can transfer a file from region B′ when the operation system of B does not work or even when the whole device B does not work. In the latter case region B′ may be operated with its own power resource.

At 301, a session initiation request from device A is received by device B. As a result, device B decides about the acknowledgement of the request.

At 305, which occurs if device B acknowledges the session initiation request, the session is validated by device B and A by analyzing parameters related to the session. The parameters include the type of the session, the history of communication, the resources and the risks. Example of communication sessions are transferring files, sharing resources, and authenticating a user.

At 310 which occurs if the session is not approved by device B or device A, each of the devices selects the strategy for the scenario. Examples of such strategies are trying to authenticating, faking an identity, updating history files and improving artificial intelligence functions that are associated with the authenticating, communication and/or certification. The strategy may be based on available resources and on the environment.

At 3101 each device decides based on the strategies of both devices, if to the session has to be continued or not.

If the decision is to terminate the session, the operation of both devices resumes to 301; otherwise the scenario is investigated by both devices 311 for assessing risks; for example if a denial of service attack is suspected, the attack is investigated.

Steps 306, 307, 308 309 3091 and 3092 occur if session request and the type of session are acknowledged by B and A.

At 306, the specification for partitioning region A in B are sent from A and are received by B. The specification may include required architecture, such as for example size of memory, number of CPUs, number of communication lines, peripherals required, power and/or clock architecture etc. The specification may be included in a file or may be defined by an interactive session in which device A requests resources and device B.

At 307 device B partition the region A′ according to the specifications. For example, device B may partition the requested memory and may provide address map. In another example device B partitions a WIFI port for controlling a CPU. Device B provides device A access to region A′. The access may be used for controlling and/or for monitoring and/or for receiving data from device B and for transferring data to device B.

At 308 device A operates region A′, for example by executing functions.

At 309 device B copies to A′ a specification for operating region B′ in device A.

At 3091 device A partition the region B′ for device A according to specifications of 309.

At 3092 device B operates region B′

At 304, which occurs after the two regions are built and authenticated, a unique protocol is built interactively. For example the devices may decide on the clock rate, power level and synchronize patterns. It should be noted that the protocol may be changed randomly or according to identifying a threat or changes in the performance of the communication.

At 302 which occur if device B did not acknowledge the session initiation request, device B checks consistency of the connectivity behavior of device A with regard to previous connection sessions. For example, device B may check that device A is not a robot attacker.

At 303 a history of communication with device A is updated. The operation resumes to 301.

At 313, which occurs at any point during the session, the strategy of the devices may be changed according to changes of the environment and resources or changes in the behavior of the user. The Strategy of the device may change the protocol.

At 314, a check is done to verify if the session has terminated. If the session has been terminated, then the operation resumes to 301, otherwise the operation may resume to 304.

It should be noted that though the communication protocol is described with two devices, the communication may be performed by any plurality of devices.

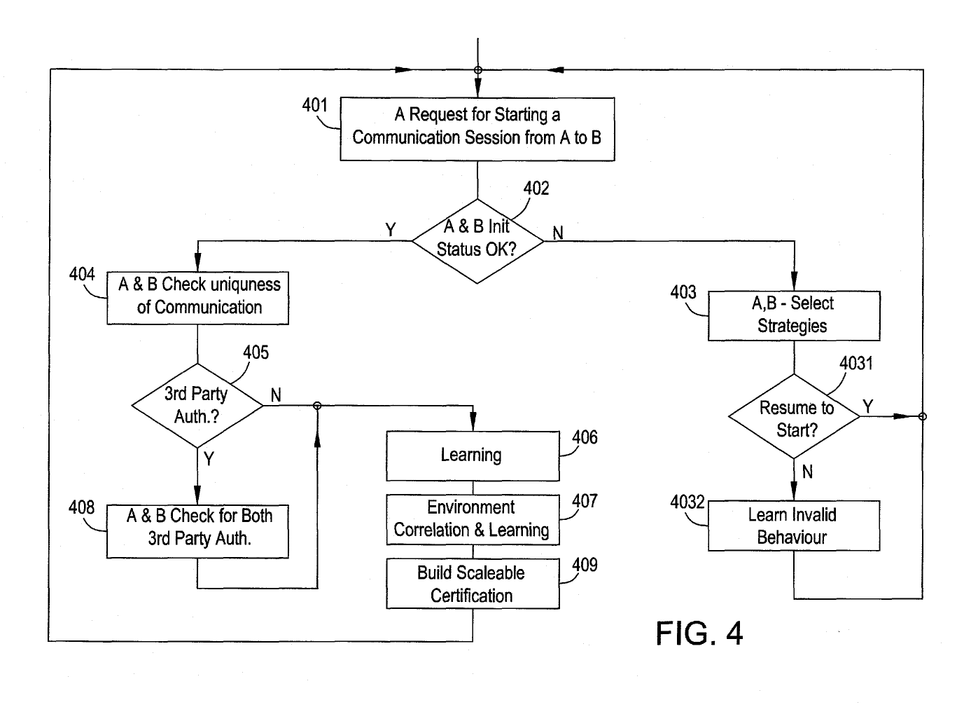

FIG. 4 shows a flowchart diagram of a trusted certification method, in accordance with some exemplary embodiments of the disclosed subject matter. According to some embodiments a certification process is performed at the initialization of the session and also during the session. The certification process is for authenticating one device by the other device.

At 401 start communication request is sent from device A to device B.

At 402 device A and device B check the status of the initiating of the session.

At 403, which occurs if the status of communication is not correct, the strategy for operating is selected by A and B. Examples of such strategies are trying to authenticate the other side and faking an identity. According to some embodiments the strategy is selected according to an analysis of resources.

At 4031 a decision whether to terminate the session is determined. If the decision is positive then the operation resumes to 401, otherwise the invalid behavior is learnt at 4032.

At 404, which occurs if the status of communication is correct, the uniqueness of the communication is checked by both device A and device B. According to some embodiments, the communication protocol between device A and device B is unique to the session. Since the communication protocol is unique to the session, the protocol can only be used for communicating between device A and device B. Thus, any attempt to use the protocol for communicating with another device is expected to fail. The uniqueness of the protocol can be checked, for example, by trying to communicate with a third device or with this device. A success of such a communication may lead to a conclusion that the protocol is not unique and thus, the session is not certified any more. Such a case may occurs, for example, when an attacker succeeds to change the communication protocol of device A and device B.

At 405, the devices check if a third party authentication is required. A third party authentication may be done by a third server that receives identifications from device A and device B and authenticates device A and device B according to the identifications.

If a third party authentication is required operation continues to 408, otherwise operation continues to 406.

At 408 a third party authentication is performed and operation continues to 406.

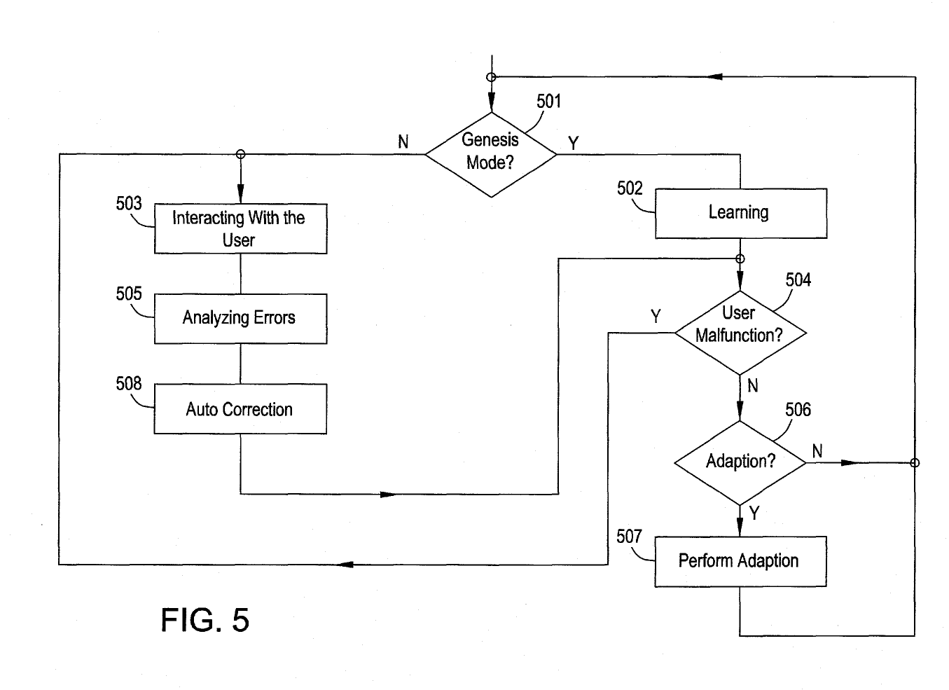

AT 406, each device learns the other device, the behavior, of the user of this device and the behavior and architecture of the other device. For example, if the other device does not have monitoring means such as a camera and microphone, the other device may be scored with a low level of trust. The learning of the behavior of the user is explained in greater details in FIG. 5.

At 407 each device combines internal data with data received from other electronic entities and analyzes the combined data for determining if the other device is in the common-environment. For example, an image from device A can be compared with an image of device B for determining that the two computerized device are in the same area.

At 409 the scalable certificate is generated. The certificate is a combination of results of tests that have been performed in 406 and 409. In one embodiment each result has a weight and the certificate is calculated by combining the results according to their weight and by comparing the results to threshold. In some embodiments the weights and the threshold are dynamically changed.

FIG. 5 shows a flowchart diagram of a method for securing and certifying the communication according to the behavior of the user. Such learning may also improve the operation of the user and the usability of the device.

At 501 a check is done to determine if the system is in genesis mode. The genesis mode is a mode in which the user and/or the environment is unknown to the device. The check is performed by comparing a behavior of a current user to a history of user behavior and by comparing the current environment to a history of the environment.

Steps 502, 504, 506 and 507 are performed if the system is in genesis mode.

At 502, the system learns the environment. The system analyses data that is provided by the sensors. For example, the system may deduct that an object is approaching the computerized device, or that the light is changed, or that the computerized device is being touched.

At 504, a mal function or a correction of a mal function of the user is detected. A mal function may be a fault of the user or a non conventional usage of the computerized device. An example of such a mal function is a spelling mistake; another example is a non conventional usage is when the user holds a cellular phone very close to his eyes.

Steps 506 and 507 are performed if a mal function or a correction is not detected.

At 506, a check is done to verify that an adaptation of the system to the user behavior and operation can be done. For example, the user may operate an application that uses most of the resources of the system and there is a risk to borrow resources from another device.

If the answerer to 506 is positive then at 507, the communication protocol is adapted to the behavior of the user while learning the user behavior. Example of adaptations are, if the user asks to communicate with a first sever and such a communication may cause a security problem, the system may change the security level of the communication or may choose another server with which the user may communicate and which may provide the same services as the first device. The adaptation may also be by updating the certification of the device. For example, device B may learn the behavior of a user who operates device A. The learning may be through region B′ that resides on device A. Device B may change the certification of device A as a result of detecting a suspicious behavior of the user. Operation resumes to 501.

If the answerer to 506 is negative (adaptation cannot be done, for example due to lack of resources) the operation resumes to 501.

Steps 503, 505 and 508 are performed if the if a mal function is detected or if the system is not in genesis mode.

At 503, the system interacts with the user and the device in order to adapt the communication session to the user behavior and in order to certify the communication session. In one case, the system monitors the behavior of the user with the camera, the system may; for example, checks if the device allows a user to transfer an image that was taking by him to another device. The system may block the transmitting and may stop the communication session as a result of such an attempt by the user.

At 505, the system analyses errors related the user, the device and the environment. For example if the system detects, by a proximity sensor, that another person is in proximity, the system may decide to terminate the communication session.

At 508, a correction is performed in order to improve the security protocol. For example, if the user allocates extra resources for running an application, the resources may be allocated for the communication session.

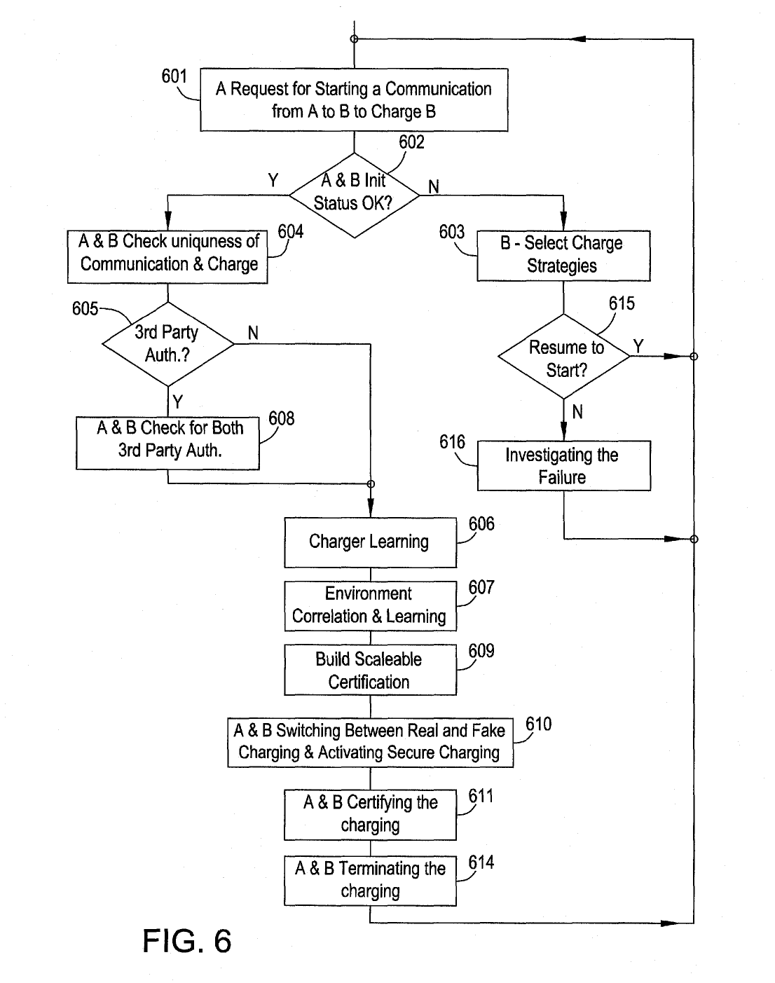

FIG. 6 shows a flowchart diagram of a method for secure charging, in accordance with some exemplary embodiments of the disclosed subject matter. According to some embodiment there is provided a communication protocol for charging which is unique to the charger, to the charged device and to the charging session. Such a protocol enables the authenticating of the charger while securing the charging from an attack. In some embodiments the protocol is implemented by the trusted communication method which is described in greater details in FIG. 3.

At 601 a request that is sent from the charger to the device to start a communication session.

At 602 the status of the session initiation between the charger and the device that needs the charging is checked. Steps 603, 615 and 616 are performed if the status is not correct.

At 603 the charged device selects charge strategies, for example the charged device may select period of charging or charging with minimal heating for avoiding DPA.

At 615 the charged device decides if learning is required.

If learning is required then at 616 the charger investigates the cause of the communication failure; operation resumes to 601.

At 604 the uniqueness of the communication is checked.

At 605 both devices check if an authentication by a third party is required.

If the authentication is required, the authentication may performed by a third party at 608 and operation continues at 606.

Otherwise, operation continues at 606

At 606, which occurs if the initiation of the communication session succeed, the charger and the charged device learn the charging and communication and verify that the communication is unique. For example the devices investigate the energy consumption of the charging process. The learning is for certifying the charger.

At 607, the environment is learnt by both devices.

At 609, a scalable certification is built. 610 the secure charging is activated. In some embodiments the securing is performed by switching between charging the required battery and charging another battery. In some embodiments the securing is performed by changing the energy level with correlation to the charger in order to avoid trapping. In some embodiments the decoy is analyzed and the energy of the charging is changed accordingly.

At 611—The charged device and the charger certify the charging and the connection with the charger during the charging. At 614 the charger and the charged device secure the termination of the charging for avoiding the learning of the rate of charging.

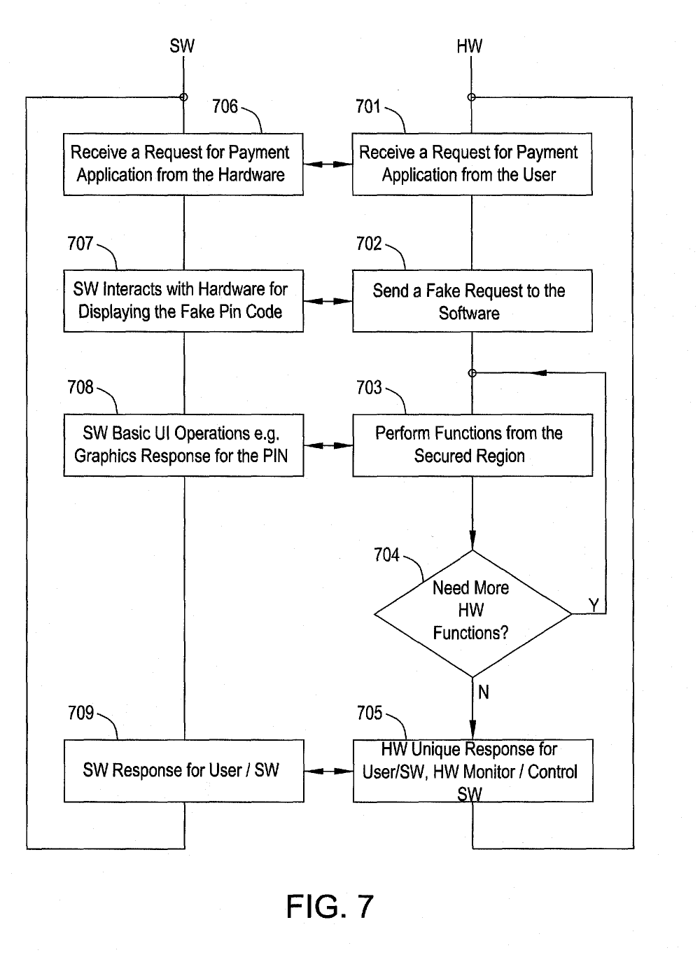

FIG. 7 shows an exemplary scenario of using the region for interacting with peripherals in accordance with some exemplary embodiments of the disclosed subject such that a secured module controls a non secured module for performing an application. For example a hardware secure module controls a non secured software module that performs a payment application such that the operations that require security are performed by the hardware module transparently to the operation of the software module. For example the hardware module may perform the actual request for an actual pin number and the actual transferring of the actual pin number to a payment server while transferring to the software module a fake number. It should be noted that both the non-secured and the secured module may operate on the same operating system. The data that is received from the user and that is sent to another computer is always controlled by a secured module which determines which data to display to the user and which data to send to the payment application.

AT 701 the hardware module waits for security events. An example of such security event is choosing the payment icon for activating a payment application. When the hardware module identifies such an event, the hardware module authenticates the user and sends a request to the software module for activating an application.

At 706 the SW module receives a request from the hardware for activating a payment application.

At 702 the hardware module sends a fake request to the software. Such a request may be a request for transaction info.

At 707 the software module responses to the hardware request by sending the requested data.

At 703 the HW performs the real functions that are selected from the security libraries. In some embodiments the functions reside in the secured region. For example the hardware module requests a pin code from the user. Additionally, the hardware module sends a fake PIN code to the software. In some embodiments, the region is controlled by the payment server such that the payment server can read the PIN number from the region.

At 704 a check is done to identify if more functions are required by the hardware module. If more functions are required then operation resumes to 703.

At 708 the software module interacts with the hardware for displaying the fake pin code.

At 705 the hardware determines, according to security criteria, which pin code is displayed to the user, which of the two pin codes is sent to the payment server and the protocol for sending the pin number.

At 709, the software may response to the user.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1-21. (canceled)

22. In a first electronic entity, said first electronic entity comprising an at least one resource, a method for authenticating said first electronic entity by a second electronic entity, the method comprising:
receiving, from said second electronic entity, a request for authenticating said first electronic entity;
partitioning said an at least one resource as a result of said receiving said request, and
providing to said second electronic entity an access permission to said at least one resource, wherein said access permission being for said authenticating said first electronic entity by said second electronic entity; said authenticating being by utilizing said at least one resource by said second electronic entity; thereby enabling said second electronic entity the authenticating of said first electronic entity by utilizing said at least one resource.

23. The method of claim 22, wherein said at least one resource being one member of a group consisting of a memory partition, a disk partition, software logic, a chip partition, a control resource, an analog component, a digital component, a signal, a mix signal and a hardware logic;

24. The method of claim 22, wherein said authenticating said first electronic entity being for one member of a group consisting of communicating with said first electronic entity, utilizing said at least one resource by said first electronic entity and for manipulating data or structure of said first electronic entity.

25. The method of claim 22, further comprising:
establishing a communication session with said second electronic entity, and
utilizing said region for communicating with said second electronic entity during said communication session; thereby enabling said second electronic entity the authenticating of said first electronic entity during said communication session.

26. The method of claim 22, further comprising continuously authenticating said second electronic entity, wherein said authenticating comprising monitoring an operation of said second electronic entity with said one or more resources.

27. The method of claim 22, further comprising: negotiating with said second electronic entity for determining said at least one resource prior to said partitioning said at least one resource.

28. The method of claim 22, further comprising:
establishing a communication session with said second electronic entity;
continuously negotiating with said second electronic entity for generating a communication protocol for communicating with said second electronic entity during said communication session, and continuously changing said communication protocol, during said session.

29. The method of claim 28, further comprising: utilizing said communication protocol for charging or changing characteristic of said charging during said charging, thereby providing a secured charging; wherein said charging being changed during said communication session thereby providing a secure charging.

30. The method of claim 22 farther comprising utilizing said at least one resource for monitoring said second electronic entity, by said monitoring, authenticating said second electronic entity and certifying said second electronic entity, according to one member of a group consisting of: utilizing said at least one resource for monitoring changes in an operation of said second electronic entity, utilizing said at least one resource for monitoring changes in a behavior of a user of said second electronic entity and utilizing said at least one resource for monitoring changes in an environment of said second electronic entity.

31. The method of claim 22 farther comprising:
establishing a communication session with said second electronic entity;
negotiating with said second electronic entity for determining characteristic of a communication protocol,
utilizing said communication protocol for communicating with said second electronic entity and adapting said communication protocol to characteristic of said session wherein said characteristic being one member of a group consisting of behavior of a user, and environment changes, changes in operation of said first electronic entity and said second electronic entity.

32. A method for certifying an electronic entity, the method comprising the steps of:
establishing a communication session with a electronic entity and
certifying, during said communication session, said electronic entity, wherein said certifying being changed during said session according to one member of a group consisting of: changes in an operation of said first electronic entity, changes in a behavior of a user of said first electronic entity and to changes in an environment of said first electronic entity.

33. The method of claim 22, further comprising receiving a first input from a peripheral;
sending a second input to a non secured module; wherein said second input being fake input;
by said second electronic entity sending a request for said secure module for reflecting said second input;
analyzing security and authentication aspects of said communication session and providing a result, and reflecting said second input and said first input in accordance with said result.

34. In a first electronic entity, said first electronic entity comprising an at least one resource, a method for sharing resources of said first electronic entity by a second electronic entity, the method comprising:
receiving, from said second electronic entity, a request for sharing said at least one resource with said first electronic entity;
partitioning said an at least one resource as a result of said receiving said request, and
providing to said second electronic entity an access permission to said at least one resource, wherein said access permission being for sharing said at least one resource by said second electronic entity.

35. In a first electronic entity, said first electronic entity comprising an at least one resource, a method for authenticating said first electronic entity by a second electronic entity, the method comprising:
receiving, from said second electronic entity, a request for authenticating said first electronic entity;
partitioning said an at least one resource as a result of said receiving said request, and
providing to said second electronic entity an access permission to said at least one resource; wherein said access permission being for authenticating said at least one resources by said second electronic entity; thereby enabling said second electronic entity the authenticating of said at least one resource entity by utilizing said at least one resource.

36. An electronic entity, said electronic entity comprising an at least one resource, said electronic entity is operable for receiving, from a second electronic entity, a request for authenticating said electronic entity; partitioning said an at least one resource as a result of said receiving said request; and
providing to said second electronic entity an access permission to said at least one resource; wherein said access permission being for said authenticating said first electronic entity by said second electronic entity; said authenticating being by utilizing said at least one resource; thereby enabling said second electronic entity the authenticating of said first electronic entity by utilizing said at least one resource.

37. The method of claim 22, wherein said at least one resource being one member of a group consisting of a control resource and a sensor.

38. An electronic entity, the electronic entity comprising a communication unit and a processing unit:
said communication unit being operable for establishing a communication session with a second electronic entity and
said processing unit being operable for certifying, during said communication session, said second electronic entity, wherein said certifying being changed during said session according to one member of a group consisting of: changes in an operation of said second electronic entity, changes in a behavior of a user of said second electronic entity and to changes in an environment of said second electronic entity.

39. An electronic entity, said electronic entity comprising an at least one resource, a communication unit and a processing unit:
said communication unit being operable for receiving, from said second electronic entity, a request for sharing said at least one resource with said first electronic entity;
said processing unit being operable for partitioning said an at least one resource as a result of said receiving said request, and for providing to said second electronic entity an access permission to said at least one resource, wherein said access permission being for sharing said at least one resource by said second electronic entity.

40. An electronic entity, said electronic entity comprising an at least one resource, a communication unit and a processing unit
said communication unit being operable for receiving, from said second electronic entity, a request for authenticating said first electronic entity;
said processing unit being operable for partitioning said an at least one resource as a result of said receiving said request, and for providing to said second electronic entity an access permission to said at least one resource; wherein said access permission being for authenticating said at least one resources by said second electronic entity; thereby enabling said second electronic entity the authenticating of said at least one resource entity by utilizing said at least one resource.
